(19) United States
(12) Patent Application Publication
(10) Pub. No.: US 2010/0090373 A1
(43) Pub. Date: Apr. 15, 2010

(54) VULCANIZATION PROCESS OF RUBBER TIRES WITH THE USE OF MICROWAVES

(76) Inventor: Julia Takahashi, Dracena (BR)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/513,968

(22) PCT Filed: May 14, 2007
(86) PCT No.: PCT/BR2007/000267

§ 371 Date: Nov. 30, 2009

(30) Foreign Application Priority Data
May 14, 2007 (BR) PI 0701702-2

(51) Int. Cl. H05B 6/64; B29D 30/54

(52) U.S. Cl. 264/490; 264/36.14

(57) ABSTRACT

Vulcanization process of rubber tires with application of premolded profile in autoclave with the use of microwaves, where rubber tires are vulcanized through microwaves heating, resulting in significant reduction of the vulcanization time when compared to the processes of conventional vulcanization, thus allowing a great productivity, due to the concentrated and homogeneous incidence of microwaves over the artifact, through its accommodation in rotating cradles inside an autoclave, also eliminating steps of chemical transformation of rubber, only needing the physical transformation to materialize the vulcanization process.

### FIELD OF THE INVENTION

The present invention is related to vulcanization processes for tires.

### BACKGROUND OF THE INVENTION

Elastomers used in tires are predominantly physical blends of natural rubber (NR) and butadiene-styrene copolymer (SBR) or NR and polybutadiene (BR). Among the most used we can mention: 1) SBR: SBR 1502, 1712, 1778; 2) (ethylene propylene diene M-class rubber) EPDM: characterized by presenting ultra-fast, fast and medium cure with varied viscosity; 3) CR: Neoprene W, WB, WHV; Baypren 210, 214; 4) NBR—all; 5) Silicon—all; and 6) Natural rubber—GEB, CCB₁ Smoked Sheet, FFB I.

Depending on the product application the elastomer type to be used is determined. However to get a good processing in the extrusion the product should present a flat surface and with good extrusion capacity, and in order to achieve it the formulator should consider some important characteristics as: gum viscosity; plasticizing degree; density and molecular structure; and necessary cure system.

After familiarizing with the rubber to be composed, the formulator will consider the systems of charges, plasticizers, protection, activation and vulcanization.

(A) The system of charges can be formed from charges of organic or mineral nature.

(1) Organic charges:

(1a) Carbon black: when a rubber compound is extruded through a matrix, it suffers a minimum incitation and subsequent shrinking. The shrinking in the extrusion is affected by the carbon black structure, particle size and charge level.

The high-structure carbon black produces low shrinking during the extrusion and the low-structure carbon black produces compounds with high shrinking during the extrusion.

Thus the compounds with high-structure carbon black produce extruded compounds with optimal dimensional stability. The choice of the type and amount of carbon black to be used in an extruded rubber compound is a decisive factor for the quality of the final product.

The influences of the carbon black type also vary in accordance with the elastomer type. In rubbers tending to crystallization, as CR-polychloroprene and NR-natural, fast alterations are observed in the properties with the addition of amounts of CB, differently from the more amorphous elastomers, as EPDM and SBR. The extruded carbon blacks that are mainly used are:

(a) N-683 or APF (all-purpose furnace)—considered as a semi-reinforcing carbon black, due its particle size but with excellent dispersion properties, due its high structure. It delivers to the product an excellent extrusion capacity and dimensional stability, allowing charging about 15% more than N-550 to reach similar results of hardness.

(b) N-550 or FEF (fast extrusion furnace)—considered as a semi-reinforcing carbon black, it has high structure and is broadly used in the composition of extruded articles.

(c) N-339 or HAF-HS (high abrasion furnace)—considered as a reinforcing carbon black, HAF has high structure besides small particle size. It should be used together with N-550 when increasing the tension, module and abrasion resistance properties in the rubber compound is desired. Due to its small particle size and high structure, the compounds produced with this type of CB have higher money viscosity (rigidity of the material before the vulcanization), also increasing the heat generation during the blend process and during the extrusion.

(2) Mineral charges: they are broadly used in the production of compounds to rubber extrusion, since they deliver some very important properties to the materials. Most of mineral charges reduce the cost of the compound; reduce the expansion factor and profile shrinking during the extrusion; stabilize the viscosity of the compound; reduce the increase of heat during the process of blend and extrusion; usually present fast incorporation, except to precipitated powdered silica; and have low volatile content, not provoking porosities.

(3) White charges:

(3a) Calcium carbonate: it can be of natural or precipitate type, broadly used as stuffing charge in rubber compounds for extrusion. It is compatible with most of elastomers, has low cost, but does not deliver to the extruded product any benefit of superficial finishing, and in some cases may compromise the appearance, if it does not present a very well controlled granulometry. It also presents differentiated abrasion properties during the blend and extrusion process delivering low wear to the extrusion and cut tools.

(3b) Natural kaolin: its main characteristic is its low cost. It may be added in great amounts, if the polymer is able to absorb it. Another important point is the compound viscosity, since even by adding a great amount of kaolin the compound is still very well extrudable, due to its interference in the hardness and viscosity being almost insignificant. If the kaolin presents a good granulometry, it may offer a surface with good finishing, with several advantages. This advantages include: high abrasion property, delivering wearing to rotors and bambury camera, extruding thread and case, matrix, cut tool; interference in the cure system, leading to the need of neutralization of its acidity; and moistness, causing porosity in the product.

(4) Other natural mineral charges:

(4a) Quartz: used as charge to silicon compounds. With high abrasion property and low reinforcement, compromises some material characteristics.

(4b) Diatomite: used as stuffing charge when it is desired to improve resistance properties. It can be used with charge of silicon compounds, and also presenting low cost.

(5) Special mineral charges:

(5a) Precipitated silica: it is only used when it is necessary to obtain physical properties with high rupture tension, low tearing module, and high rupture elongation. It is very used in the hose industry, and in articles of clear color. The main disadvantage is the great interference in the vulcanization system, provoking a fast air aging of the compounds, increasing the viscosity of the compound and making difficult the extrusion. It may cause porosity in the extruded article, due its high moisture content (in some cases up to 7% in weight).

(5b) Granulated precipitated silica: it presents the same characteristics of the powdered silica but with the advantage related to the weight and incorporation in the compound and does not present the trend to be suspended in the air.

(5c) Sodium aluminate silica: it may be used as stuffing charge with very low reinforcing property. In relation to precipitated silica it presents a small influence in the vulcanization process, and it is of easier processing, but with higher cost.

(5d) Treated kaolin: it may be hydrated, calcined or signaled. It delivers better physical characteristics to the compounds, keep on being abrasive and it is still very used in the wire and cable industry, by having insulating properties. The signaled ones deliver larger reinforcement property in some buyable types with precipitate silica.

(5e) Mistron steam: it presents an excellent quality for application in extruded products of clear color. It is fine and selected mineral talc, with very well controlled granulometry, good reinforcement characteristics to the rubber, and very good extrusion capacity and dispersion characteristics. It has as disadvantage its high cost and difficulty of being found.

(5f) Sillitin: it is a mineral compound formed by aluminum silicate (kaolinite) and quartz. Its crystalline structure delivers some particular characteristics related to the compounds that will be extruded. The crystalline structure of the quartz (natural silica) is amorphous corpuscular, it is to say, without defined shape—the structure of the kaolinite is lamellar. The final structure of the sillitin compound (Neuburg silica) is composed.

It may be defined that the sillitin structure is branched: between two kaolinite lamellar particles it presents a corpuscular rugous particle of silica. The sillitin is a natural mineral charge extracted from the Neuburg region in Germany. The obtaining and improvement process is particular and very low granulometries are reached, still keeping its natural crystalline structure, with the following advantages: high-speed incorporation to the blend, excellent dispersion properties; delivers excellent characteristics of extrusion and dimensional stability; high charge degree; low content of volatile materials, not presenting porosity in compounds vulcanized without pressure; and very high chemical resistance and aging resistance.

(B) Protection systems: broadly used for the production of articles that need good aging properties, weather and high temperature resistance, allied to special characteristics such as: resistance to oils (nitric rubber); abrasion resistance and general use (SBR); high elasticity and mechanical resistance (Natural); and resistance to grease, high adhesiveness (CR).

Use of antioxidants and anti-ionizing: the use will be necessary when the elastomer does not present as intrinsic properties such resistance characteristics. Rubbers as EPDM and silicon don't require the addition of such products, except when the specification is very rigorous, such as for use in high-pressure automotive hoses, for example. Table 1 presents a list of possible antioxidant or anti-ionizing elements.

| Chemical nature | Trade name | Function |
|---|---|---|
| TMQ | Angerite Resis D (Vanderbilt) | Heat stabilizer |
| (1,2-dihydro,2,2,4-trimethylquinoline) | Flectol H (Monsanto) | |
| | Naugard Q (Uniroyal) | |
| 4,4′-thio-bis-(6-t-butyl-m-cresol) | Santonox R - Monsanto | Heat stabilizer |
| Tetrakis | Irganox 1010 (Ciba Geigy) | Heat stabilizer |
| [methylene(3,5-di-t-butyl-4- | | |
| hydroxyhydrocinnamate)]methane | | |
| 2-mercapto-benzimidazole | Vulcanox MB (Bayer) | Antioxidizing |
| | Vanox MTI (Vanderbilt) | |
| Zinc salt of mercapto-benzimidazole | Vulcanox ZMB2 (Bayer) | Heat stabilizer |
| | Vanox ZMTI (Vanderbilt) | |
| Blend of mercapto-benzimidazole | Permanax CNS (Flexsys) | Copper inhibitor |
| and bis-[2-hydroxy-5-mehyl-3-(1- | | |
| methyl-cyclohexyl)-phenyl]-methane | | |
| N,N-bis-[3(3′,5′-di-t-butyl-4′- | Irganox MD 1024 (Ciba Geigy) | Antioxidizing |
| hydrophenyl)-proponyl]-hydrazine | | |

(C) Plasticizers: they are a group of raw materials used in the production of compounds of extruded rubber. Particularly this product has a great importance, due its performance be directly related to the behavior of process of blend, extrusion, vulcanization and after-vulcanization. It should be highlighted it is necessary to observe the great compatibility differences between rubbers and plasticizers, as for example:

(1) EPDM—paraffinic-naphtenic plasticizer.

(2) SBR—aromatic and paraffinic plasticizer.

(3) CR—aromatic plasticizer, DOP, polymeric.

(4) Natural—aromatic and paraffinic plasticizer.

(5) NBR—polymeric plasticizer, DOP, DOS, aromatic.

(6) Silicone—only silicone oil.

The quantity of plasticizer that can be incorporated in a compound is limited by the quantity of carbon black and clear charges and by the own characteristics of the polymer. For each vulcanization process after extrusion it should be observed the vulcanization temperatures and define a plasticizer type that has as minimum flash point the value of 20° C. above the cure temperature.

(D) Acceleration systems: this are developed to obtain certain characteristics such as: process safety during the extrusion or to support the extrusion process without beginning pre-vulcanization or reaction, a very common problem in extruded articles production; provide a not very long time and not very high vulcanization temperature at the beginning of vulcanization process to not collapse the profile; and provide a short final time of vulcanization to reach high speeds of vulcanization and do not migrate to the piece surface.

(D1) Accelerators classification: from the point of view of vulcanization speed, the accelerators are classified as:

(1) Slow: DPG, DOTG.

(2) Fast: TETD, TMTD, TMTM.

(3) Very fast: ZMDC, ZEDC, ABDC.

(4) Ultra-fast: dithiocarbamates of Se, Pb, Cu, Te, Cd, Bi

(5) Fast with delayed action: sulfenamides.

It should be observed that to reach a balanced vulcanization it is imperative to reach a synergic effect among the accelerators, to classify them as primary and secondary. To each rubber type a characteristic acceleration is developed, where in particular the sponges need more reinforced systems of acceleration, due to the interference of the high amounts of added plasticizers.

(E) Sponging agents: these are products that, when reaching a certain temperature, start a decomposition process, resulting in the formation of gases (nitrogen or byproducts). Each sponging agent has a characteristic temperature, speed and quantity of gases. In the production of extruded sponged products, the artifact is vulcanized with hot air, salt bath and UHF, and the used sponging agent should be combined with the system and vulcanization times, since it can not decompose before nor after the vulcanization, but during the vulcanization. The cell size depends directly on the size of the sponging particle.

Recapping of diagonal tires: it has started in Brazil in the 1950s, being practiced through molds in press. This recapping model was improved in the 1960s, with the development of presses with 3-parts frontal opening, having as function to reach the recapping and resoling. During this period, a process with exclusive function of providing resoling was developed, using a mold in a ring shape. These recapping and resoling processes were broadly used up to middle of 1980s, when the “radial tire” appeared in the automobile market.

Recapping of radial tires: this type of tire, by presenting a totally differentiated structure from the diagonal tires, demanded the development of alternative processes of recapping, technically called “vulcanization processes”.

Vulcanization process: it consists on the application of heat and pressure to a rubber compound, formed by double links along the molecular chain that technically can be translated by the change of the chemical structure of an elastomeric compound. This change happens in the crossed links among the chains, transforming what was an entangled of separate chains in a three-dimensional unified net. In this process the plasticity of the compound proportionally decreases to the increase of this net of crossed links, at the same time that increases the elasticity. In practice, the recovery of a deformation is never perfect, always having a residual plasticity in a vulcanized rubber, which is called “permanent deformation”.

In old times, the vulcanization consisted of mixing sulfur to the rubber with application of heat, to reach the crossed links among the molecule chains. However this procedure demanded a very long time. To minimize this inconvenience the vulcanization process has changed to the introduction of sulfur, and additionally of accelerating and activator elements, that aid in the reduction of the reaction time.

Vulcanization in synthetic rubbers: by being saturated these rubbers are characterized by not having chains with double links, and therefore cannot be vulcanized only with sulfur. In these cases, more reactive chemical products are used, such as peroxides, to reach the crosses links necessary to the correct vulcanization process.

Parameters considered in the vulcanization: the determination of the method and vulcanization conditions, such as: time, temperature and pressure; should take into account the type of employed composition (natural rubber or synthetic rubber), as well as the dimensions of the artifact to be produced. It should also consider the end of the product, where this definition determines the properties of the obtained final product.

Artifact to be produced: this determination is more critical for the artifacts of thick walls, since to obtain an adequate vulcanization in its interior, sometimes an over-vulcanization occurs in the surfaces. In general, as a resource to minimize this problem, it is used lower temperatures and longer times.

Elements used for obtaining the artifact: to obtain a recapped it is imperative the use of the following items:

(a) Camelback: it is a rubber profile with a link film between the tread and the carcass, being this tread still in the plastic state without vulcanization, and will receive pressing in molds that made the desired drawing for the customer's application.

(b) Premolded: it is a molded rubber profile with a shape according to the needs of the user's application, which is already vulcanized and is applied with a link film to anchor this tread to the carcass.

Types of molds: for the conforming of the recapped tire several molds are used, which are specified in accordance with the artifact type that is being produced. Among them we can highlight:

(1) Compression molds: these are the most used and consist of two or more machined steel plates in the shape of the artifact. In its making the contraction that the artifact will suffer after being cooled to room temperature must considered, which varies in accordance with the formulation type, but may be estimated as about 1.5%. They may still have one or more cavities, depending on the artifact size, the press size and the related cost.

(1a) Direct comprehension: usually the mold has two parts: the base, containing one or more cavities and having channels that facilitate the drainage of the excess of mass, escape of air; and a covering plate. Its making is cheaper and has as advantage the better heat transfer than the other types. The cavities should be charged with excess of compound in order to allow a uniform distribution of the pressure over the artifact.

(1b) Positive or piston type: the piston penetrates in the mold cavity, assuring the whole pressure be directly applied to the compound during the molding. The absence of drainage channels requires a rigorous control of the material volume in order to avoid changes in the artifact dimensions.

(1c) Semi-positive: it presents some advantage over the two previous types, where the piston has a small penetration in the cavity, thus allowing the exit of the excess of material through the drainage channels, not requiring a so rigorous control of the material volume. When closing the mold, there is metal-metal contact in such a way that, as in the mold of direct compression, the pressure over the compound during the vulcanization is not totally exercised by the press. Thus the pressure exercised over the compound during the vulcanization is larger than the direct comprehension and smaller than the positive molds.

(2) Transfer molds: it is constituted in three sections, being the cavity limited by the central and superior sections. In the superior part of the central section there are cavities generally in a cylindrical shape, where the compound is introduced. The compound is compressed by a piston, along slim transfer channels to the molding cavity.

These molds are larger and heavier than the compression ones and require a rigorous periodic maintenance due to its conformation. They should only be used for artifacts that need very accurate dimensions, and should not have, therefore, burrs in certain places.

The vulcanization time of the compound, generally shorter for this mold type, is due to the fact that this one arrives to the molding cavity at high temperatures, caused by the heat developed during its passage through the feeding channels, where in complement it presents a not very low viscosity, facilitating the expulsion of the existent air in the cavity.

(3) Injection molds: it is similar to the transfer type, but its cavities are fed after the closing of the mold, forcing the compound through the conductive channels. The injection is performed in a special equipment and has as main advantages related to the conventional methods of molding for compression, a larger production due to the smallest time of vulcanization, elimination of the compound preparation for the molding and larger uniformity of the final artifact, reducing the refuse level, leading to lower final costs, more uniform cure in thick pieces and labor reduction. Its use is only justified for great-scale productions, due to its complexity and high capital expenditure.

Inner tube protector: technically denominated as flap, it is used in transport tires, whose main function is to protect the inner tube of the heat generated by the drum brake. It is made by a non-butylic elastomer compound, being vulcanized in “Adamson”-type presses. Its dimensions vary from 16L (“delivery” tires) to 24V (“tractor” tires).

Flap vulcanization system: it consists of the application of heat and pressure to a rubber compound, in order to reach the desired shape and properties, where the exact determination of the method and vulcanization conditions (time, temperature and pressure) should be done not only considering the employed composition, but also the artifact dimensions and its application.

Equipment and type of vulcanization systems: to make viable the vulcanization process, several specific systems were idealized, as for example, pressing system, direct steam system, dry air system, continuous system, and high frequency system among others, each one using different equipment, such as: sector press of closing in six similar parts with millimeter-precision molds, control system and vulcanization automation; automated vulcanization steam-autoclaves; and hot air vulcanization autoclaves fully automatic heated by electric resistors, or steam coils or thermal fluid totally automatic.

Vulcanization system by pressing: this is the most common industrial application, which is characterized by heating the presses, manual or hydraulic ones (manufactured with several sizes of plates and number of cavities), with steam or electrical resistors, where the steam heating is cheaper and allows easier temperature control. However, the electrical heating allows working with higher temperatures, above 180° C.

A specific equipment is used to shape the tire, during the vulcanization. This equipment is known as bladder, where the first tire is shaped out of the press. At its hand the bladder has finer walls, allowing faster cures, besides having a simplified operation.

This equipment compresses and holds the tire to be vulcanized against the mold surface during the vulcanization process, where the applied force reproduces the form of tread and the heat (more commonly generated by steam) is usually introduced in the bladder to help the vulcanization process.

Also in the scope of the equipment to tire shaping, the bladder has a significant role in the production cost, being imperative to obtain the largest possible number of vulcanizations before discarding it.

Obtaining of the bladder: it is manufactured by the extrusion of a special butyl compound, with a valve of the same compound, and vulcanized in molds with internal air pressure.

Application of the bladder: it is put inside the tire to be vulcanized in shaping machines. To vulcanize big tires as the ones of rear tractors, trucks, and snow removers, it is generally used an individual press or an autoclave press (watchcase), where this last one has the advantage of automatically opening at the end of the vulcanization. Individual molds are used, each one containing a tire and a bladder. The vulcanization time varies in accordance with the tire size; the tires that require a great number of canvases require a long vulcanization.

Also in the scope of the types of presses used in the vulcanization process, nowadays double vulcanizing presses (called Bag-O-Matic—TRADEMARK) are used. These presses are characterized by vulcanizing with bladder and in only one operation they pre-shape and vulcanize the tires.

Inflation of the vulcanized tire: when the tire leaves the press it automatically enters in a ring where it is inflated with air during a cycle that is similar to the one of the vulcanization; this inflation is necessary to gradually cool the carcass under tension, avoiding the deformation of the tire when it is used. In this post-vulcanization process, depending on the size and use of the truck tire, it receives up to 2 inflation cycles after the vulcanization. Finally, after this procedure the tires are burred, externally checked and finally released for shipment.

### SUMMARY OF THE INVENTION

The present invention seeks to provide a vulcanization process for a rubber tire having an internal and an external surface, the process comprising the steps of:

(1) preparing the tire, the preparation comprising: (1a) examining the tire; (1b) scratching the external surface of the tire; (1c) repairing the tire; (1d) applying a link rubber to the external surface of the tire; (1e) applying a premolded camelback rubber over the link rubber and external surface of the tire, containing carbon black; together with a corresponding junction; (1f) inserting the tire in a press, placing a tread mold in contact with the external surface of the tire; (1g) vulcanizing the camelback rubber and the corresponding junction with the tire, the tread mold defining the tread drawing; (2) vulcanizing the tire, the vulcanization comprising: (2a) assembling the tire in a wheel with an inner tube with a protective device, in the internal surface; (2b) wrapping the tire with a bladder; (2c) accommodating the tire on a rotating cradle inside an autoclave; (2d) heating the autoclave; (2e) applying microwaves directly to the tire; (2f) physically transforming the rubber by heating the premolded camelback rubber to a predetermined temperature higher than the temperature of the tire, and sufficient for generating heating to bring the link rubber to the vulcanization point; (2g) vulcanizing the tire.

The present invention also seeks to provide a vulcanization process for a rubber tire having an internal and an external surface, the process comprising the steps of: (1) preparing the tire, the preparation comprising: (1a) examining the tire; (1b) scratching the external surface of the tire; (1c) repairing the tire;(1d) introducing a connection layer on the external surface of the tire; (1e) applying premolded vulcanized rubber with a tread drawing over the connection rubber layer; (2) vulcanizing the tire, the vulcanization comprising: (2a) assembling the tire in a wheel with an inner tube with a protective device, in the internal surface; (2b) wrapping the tire with a bladder; (2c) accommodating the tire on a rotating cradle inside an autoclave; (2d) heating the autoclave; (2e) applying microwaves directly to the tire; (2f) physically transforming the rubber by heating the premolded camelback rubber to a predetermined temperature higher than the temperature of the tire, and sufficient for generating heating to bring the connection rubber layer to the vulcanization point; (2g) vulcanizing the tire.

The present invention also seeks to provide a vulcanization process for a rubber tire having an internal and an external surface, the process comprising the steps of: (1) preparing the tire, the preparation comprising: (1a) examining the tire; (1b) scratching the external surface of the tire; (1c) repairing the tire; (1d) applying a link rubber to the external surface of the tire; (1e) applying a premolded camelback rubber over the link rubber and external surface of the tire, containing carbon black; together with a corresponding junction; (1f) inserting the tire in a press, placing a tread mold in contact with the external surface of the tire; (1g) vulcanizing the camelback rubber and the corresponding junction with the tire, the tread mold defining the tread drawing; (2) vulcanizing the tire, the vulcanization comprising: (2a) assembling the tire by installing a sealing ring in the stub; (2b) wrapping the tire with a bladder; (2c) applying vacuum inside the bladder, to the internal and an external surface of the tire; (2d) accommodating the tire on a rotating cradle inside an autoclave; (2e) heating the autoclave; (2f) applying microwaves directly over the tire; (2g) physically transforming the rubber by heating the premolded camelback rubber to a predetermined temperature higher than the temperature of the tire, and sufficient for generating heating to bring the link rubber to the vulcanization point; (2h) vulcanizing the tire.

The present invention also seeks to provide a vulcanization process for a rubber tire having an internal and an external surface, the process comprising the steps of: (1) preparing the tire, the preparation comprising: (1a) examining the tire; (1b) scratching the external surface of the tire; (1c) repairing the tire; (1d) introducing a connection layer on the external surface of the tire; (1e) applying premolded vulcanized rubber with a tread drawing over the connection rubber layer; (2) vulcanizing the tire, the vulcanization comprising: (2a) assembling the tire by installing a sealing ring in the stub; (2b) wrapping the tire with a bladder; (2c) applying vacuum inside the bladder, to the internal and an external surface of the tire; (2d) accommodating the tire on a rotating cradle inside an autoclave; (2e) heating the autoclave; (2f) applying microwaves directly over the tire; (2g) physically transforming the rubber by heating the premolded camelback rubber to a predetermined temperature higher than the temperature of the tire, and sufficient for generating heating to bring the link rubber to the vulcanization point; (2h) vulcanizing the tire.

### DETAILED DESCRIPTION OF THE INVENTION

The vulcanization process of tires of the present invention, is based on the application of a premolded profile in an autoclave but, differently from the vulcanization processes of the state of the technique, the elastomer is subject to the effect of microwaves.

For the purpose of this invention, the following terms and concepts are defined:

Heat: the heat (abbreviated as H) is the thermal energy transferred between two bodies at different temperatures. Thus there is no sense in saying that a body has more heat than other. The heat is an energy that is transferred from a system to another, without mass transport, and that does not correspond to the execution of a mechanical work. The unit in the International System (IS) for heat is joule (J).

Heat generation: any body has defined quantity of internal energy that is related to the random movement of its atoms and molecules. This internal energy is directly proportional to its temperature. When two bodies or fluids in different temperatures interact (by contact or radiation), they change internal energy until the temperatures be the same. The amount of transferred energy is the amount of changed heat, if the system is isolated from other ways of energy transfer.

The processes of heat transfer are:

(1) Thermal conduction: it is a way of heat transfer that generally happens in solid materials, due to the heat propagation through the contact of molecules of two or more substances with different temperatures (metal, wood, ceramic, etc.).

In fluid (liquid and gas) materials the heat transfer through conduction also happens. However, in these materials the increase of temperature changes the density of the fluid in the hottest part, provoking a macroscopic movement. This displacement, which happens from the part of the hottest fluid to the coldest one, increases the speed of transport of thermal energy. This phenomenon is called convection.

(2) Convection phenomenon: it is a process of mass transportation due to the pulling of a solute by a moving solvent. The term can also be applied in heat transfer when there is a global movement and blend of macroscopic elements to different temperatures or the energy change between a fluid and a solid surface.

The mass transport due to density differences is called free or natural convection; if there is a mechanically forced movement, for example, by a pump or fan, the process is called forced convection.

(3) Radiation or irradiation: it is a form of heat transfer through electromagnetic waves, where two bodies in different temperatures tend to the thermal balance, even if between them there is no material environment. For example, the sun warming up the earth, where there is a vacuum between them.

(4) Microwaves: also called SHF (Super High Frequency), they are electromagnetic waves with larger wavelengths than the ones of the infrared rays, but smaller than the wavelength of the radio waves varying from 30 cm (1 GHz of frequency) to 1 cm (30 GHz of frequency). To the waves above 300 GHz, the absorption of the electromagnetic radiation by the earth atmosphere is so high that the atmosphere is practically opaque to the highest frequencies, until it turns again transparent in the also called infrared window up to the visible light.

Action of the microwaves: the materials react differently to the energy produced by the microwaves. In this sense they are classified as: conductive, insulating and dielectric, as better described below:

(1) Conductive materials: they are basically formed by metals. When they receive the impact of microwaves, they reflect them, just as a mirror reflects the light. Thus, for the conductive materials the microwaves do not penetrate and do not heat them.

(2) Insulating materials: in this case the transmission of microwaves happens, however with little effect or even no heating effect, similarly to the passage of the light through a glass.

(3) Dielectric materials: they represent the great majority of the materials, having intermediate properties between the insulating and the conductive materials. The microwaves penetrate the materials as to the insulating ones but unlike these, they absorb energy, where this absorption results in a heating of the dielectric material.

Heating of an elastomer by microwaves: the rubber is a dielectric material and thus it can be heated by microwaves, being its heating associated to its molecular structure. Technically the rubber molecule is called “polar”.

Thus when an elastomer is submitted to a strong microwave field, its molecules tend to be orientated in accordance with the electric field. The direction of the electric field then continually varies in fraction of seconds, which provokes an angular loss by friction and, as a consequence, the elastomer heating.

In order to obtain an efficient heating the materials should necessarily present a certain polarity. The elastomers used in the tires production are predominantly physical blends of natural rubber (NR) and butadiene-styrene (SBR) copolymer or also of NR and polybutadiene (BR).

Also in the scope of elastomer formulation applied to tires, the organic charge, especially the carbon black, is characterized by being a “semi-conductive” material. This physical condition makes the elastomer progressively loses the dielectric capacity when mixed with the polymeric materials.

Thus it is conclusive that the choice of the type and quantity of organic charge determines the possible adjustment of loss of dielectric capacity at a desired level. This condition happens due to the size of the particle of organic charge (carbon black).

This condition can be best understood knowing that the organic charge of carbon black, when below a certain content, presents small particles, such as the “ISAF”- and “HAF”-type charges, which warm up in a faster way than the observed to “FEF”- and “SRF”-type charges. The carbon black structure also influences the heating. The carbon black of low structure warms up faster than the one of high structure. Thus the increasing of the carbon black content increases the heat generation.

Use of white charges: they are usually insulating compounds and therefore the loss factor is low. In other words, the heat generated when the rubber is charged with kaolin-type or carbonate of calcium charges, the heating result is lower. For compounds charged with white charges, to reach a heating comparable to the heating obtained with carbon black it is necessary to add precipitated silica, due the size of its particles and its specific polarity.

However, the NR and SBR or BR rubbers are non-polar polymers, practically presenting no interaction with microwaves.

To avoid this limitation, meaning to make these rubbers react when exposed to microwaves, “electricity conductive charges” are used, especially carbon black.

From the technical point of view the introduction of electricity conductive charges promotes a phenomenon known as “Maxwell-Wagner polarization”, which is translated by the heating of the tire rubber, since it presents a relatively high amount of this charge type (usually carbon black).

The inedited vulcanization process of tires, with the application of premolded profiles in autoclave with heating by microwaves, of the present invention, is characterized by being of physical nature, meaning, it does not need the use of chemical reagents. This condition allows the application of high amount of energy in the artifact, and also for a short period of time, making viable a high productivity with corresponding reduction of energy consumption, leading to a reduction of industrial costs, and generating a scale effect.

The vulcanization process of the present invention has the following steps:

(1) Preparation of the artifact body: this stage, which precedes the vulcanization process, is similar to the procedures known in the prior art, which includes the following steps:

(1a) Examination of the tire;

(1b) Scratching of the tire;

(1c) Repair of the tire; and

(1d) Application of rubber to the tire: this step can have at least two variants:

In a hot vulcanization process, the rubber, called camelback, is applied over the scraped/scratched surface of the tire. In this case this rubber does not present any drawing as tread, and is also not vulcanized. In this case the tire is inserted in presses where the necessary vulcanization of the camelback occurs with its corresponding junction with the artifact carcass (in this case a tire), where the tread drawing is defined through specific molds.

In a cold vulcanization process (the most currently used by the industry), a connection layer is introduced between the rubber and the artifact carcass (tire), where the effective connection will happen during the vulcanization process (using an autoclave). In this case it should be highlighted that the premolded rubber is already properly vulcanized, being supplied with the tread drawing.

(2) Preparation for vulcanization: in this step one of two possible procedures may be used:

For conventional tire, after being properly prepared in step (1), the tire is assembled in a wheel, also receiving in its interior an inner tube and a rubber protective accessory for this inner tube. In the sequence the already assembled tire is involved by a layer of rubber called envelope or bladder.

For radial tires, this assembly procedure is more simplified. The tire receives only a sealing ring in the stub and later is covered by the envelope, where the tire is covered again by a rubber wrapping in both internal and external parts, thus creating a physical condition for vacuum formation in the artifact environment. In this case, vacuum is applied in the external and internal parts of the tire.

(3) Heating of the autoclave: microwaves are directly applied to the tire. Thus a direct heating over each artifact is reached, assuring a larger heat concentration in these specific points, and optimizing the autoclave operation.

(4) Vulcanization of the tire: this step happens by physical transformation of the rubber, where the carbon black concentration is greater in the premolded rubber disposed inside the premolded mold, meaning that this rubber presents more polarized charges in its composition. This will create a heating of the rubber when compared to the heating of the carcass, thus generating a thermal condition and a consequent heating of the link rubber that is positioned between the premolded rubber and the tire, such as a scraped tire. This is the necessary condition enable the vulcanization process of the tire.

As a complement to provide a better homogeneity in the heat distribution over the rubber previously charged inside the autoclave, the autoclaves have rotating cradles in its interior, where the tires are placed.

This condition aggregates advantages from the point of view of durability of the vulcanized tire, due to the increased life of the airbag. During the autoclave operation with microwaves it is determined that there is less exposition to lower heating temperatures, this condition reflecting on the tire carcass, which receives a smaller thermal aggression.

Additionally, and as determinant factor of differentiation, when compared to the vulcanization process in traditional autoclave, there is an expressive reduction of vulcanization time, since the microwaves technology is characterized by the speed of obtaining the heating up to the desired temperature.

Also as a consequence of this reduced vulcanization time by microwaves it is possible to verify an additional significant increase in the productivity process of making vulcanized tires.

(5) Removal of the vulcanized tire;

(6) Inflation of the vulcanized tire, and

(7) Storing or shipment of the tire.

The viability of the above process requires the use of a special equipment, which can be an adaptation of an autoclave (with all resources of pressure, temperature and time controls) with an adapted microwaves generating device. Such equipment should have a specification in accordance with the dimensions of the rubber tire to be vulcanized, as well as it should consider the heating needs and possibilities of a process of this nature in an uniform and controlled way. Particularly, on order to obtain a homogeneous heating of the tires to be vulcanized, the equipment should have several rotating cradles in its interior to accommodate the rubber tires previously prepared for vulcanization.

Also, the control of the frequency parameters, vulcanization temperature and cure time is also determined by the type and quality of the elastomeric raw material, such as: thickness; width; rubber formulation; repairs in the artifact; assembly methods, and artifact size.

1-7. (canceled)

8. A vulcanization process for a rubber tire having an internal and an external surface, the process comprising the steps of:
(1) preparing the tire, the preparation comprising:
(1a) examining the tire;
(1b) scratching the external surface of the tire;
(1c) repairing the tire;
(1d) applying a link rubber to the external surface of the tire;
(1e) applying a premolded camelback rubber over the link rubber and external surface of the tire, containing carbon black; together with a corresponding junction;
(1f) inserting the tire in a press, placing a tread mold in contact with the external surface of the tire;
(1g) vulcanizing the camelback rubber and the corresponding junction with the tire, the tread mold defining the tread drawing;
(2) vulcanizing the tire, the vulcanization comprising:
(2a) assembling the tire in a wheel with an inner tube with a protective device, in the internal surface;
(2b) wrapping the tire with a bladder;
(2c) accommodating the tire on a rotating cradle inside an autoclave;
(2d) heating the autoclave;
(2e) applying microwaves directly to the tire;
(2f) physically transforming the rubber by heating the premolded camelback rubber to a predetermined temperature higher than the temperature of the tire, and sufficient for generating heating to bring the link rubber to the vulcanization point;
(2g) vulcanizing the tire.

9. A vulcanization process for a rubber tire having an internal and an external surface, the process comprising the steps of:
(1) preparing the tire, the preparation comprising:
(1a) examining the tire;
(1b) scratching the external surface of the tire;
(1c) repairing the tire;
(1d) introducing a connection layer on the external surface of the tire
(1e) applying premolded vulcanized rubber with a tread drawing over the connection rubber layer;
(2) vulcanizing the tire, the vulcanization comprising:
(2a) assembling the tire in a wheel with an inner tube with a protective device, in the internal surface;
(2b) wrapping the tire with a bladder;
(2c) accommodating the tire on a rotating cradle inside an autoclave;
(2d) heating the autoclave;
(2e) applying microwaves directly to the tire;
(2f) physically transforming the rubber by heating the premolded camelback rubber to a predetermined temperature higher than the temperature of the tire, and sufficient for generating heating to bring the connection rubber layer to the vulcanization point;
(2g) vulcanizing the tire.

10. A vulcanization process for a rubber tire having an internal and an external surface, the process comprising the steps of:
(1) preparing the tire, the preparation comprising:
(1a) examining the tire;
(1b) scratching the external surface of the tire;
(1c) repairing the tire;
(1d) applying a link rubber to the external surface of the tire;
(1e) applying a premolded camelback rubber over the link rubber and external surface of the tire, containing carbon black; together with a corresponding junction;
(1f) inserting the tire in a press, placing a tread mold in contact with the external surface of the tire;
(1g) vulcanizing the camelback rubber and the corresponding junction with the tire, the tread mold defining the tread drawing;
(2) vulcanizing the tire, the vulcanization comprising:
(2a) assembling the tire by installing a sealing ring in the stub;
(2b) wrapping the tire with a bladder;
(2c) applying vacuum inside the bladder, to the internal and an external surface of the tire;
(2d) accommodating the tire on a rotating cradle inside an autoclave;
(2e) heating the autoclave;
(2f) applying microwaves directly over the tire;
(2g) physically transforming the rubber by heating the premolded camelback rubber to a predetermined temperature higher than the temperature of the tire, and sufficient for generating heating to bring the link rubber to the vulcanization point;
(2h) vulcanizing the tire.

11. A vulcanization process for a rubber tire having an internal and an external surface, the process comprising the steps of:
(1) preparing the tire, the preparation comprising:
(1a) examining the tire;
(1b) scratching the external surface of the tire;
(1c) repairing the tire;
(1d) introducing a connection layer on the external surface of the tire;
(1e) applying premolded vulcanized rubber with a tread drawing over the connection rubber layer;
(2) vulcanizing the tire, the vulcanization comprising:
(2a) assembling the tire by installing a sealing ring in the stub;
(2b) wrapping the tire with a bladder;
(2c) applying vacuum inside the bladder, to the internal and an external surface of the tire;
(2d) accommodating the tire on a rotating cradle inside an autoclave;
(2e) heating the autoclave;
(2f) applying microwaves directly over the tire;
(2g) physically transforming the rubber by heating the premolded camelback rubber to a predetermined temperature higher than the temperature of the tire, and sufficient for generating heating to bring the link rubber to the vulcanization point;
(2h) vulcanizing the tire.
